(19) United States
(12) Patent Application Publication
(10) Pub. No.: US 2019/0161097 A1
(43) Pub. Date: May 30, 2019

(54) Rotary Railcar

(71) Applicant: Timothy K. Searfoss, West Branch, MI (US)

(72) Inventor: Timothy K. Searfoss, West Branch, MI (US)

(21) Appl. No.: 16/199,730

(22) Filed: Nov. 26, 2018

Related U.S. Application Data
(60) Provisional application No. 62/591,107, filed on Nov. 27, 2017.

(51) Int. Cl. B61D 39/00; E05F 15/53; E05F 15/603

(52) U.S. Cl. CPC B61D 39/002; B61D 39/006; E05Y 2900/51; E05F 15/603; E05F 15/53

(57) ABSTRACT

A railcar may include a pair of opposed sidewalls, and a support disposed on the top of each sidewall. The supports are configured to engage clamps to rotate the railcar.

### CROSS-REFERENCE TO RELATED APPLICATION

This application claims priority to U.S. Provisional Patent Application No. 62/591,107, entitled “Railcar with Cover,” filed on Nov. 27, 2017, the disclosure of which is hereby expressly incorporated by reference in its entirety.

### FIELD OF THE DISCLOSURE

The present disclosure generally relates to rotary railcars.

### BACKGROUND

Railcars are widely known. Such railcars can have covers.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a perspective view of a railcar with a cover assembly, according to one embodiment of the present disclosure;

FIG. 2 is a cross-sectional view of the railcar taken along line 2-2 in FIG. 1;

FIG. 3 is a perspective view of a drive and storage unit for the cover assembly;

FIG. 4 is a perspective view cut away to show the interior of the drive and storage unit;

FIG. 5 is a side view of the interior of the drive and storage unit;

FIG. 6 is a perspective view of a drive sprocket of the cover assembly;

FIG. 7 is a perspective view of a slide of the cover assembly;

FIG. 8 is a perspective view of a lead slide of the cover assembly;

FIG. 9 is a perspective view of a cover storage assembly with a take up spool removed for clarity;

FIG. 10 is a cross-sectional view showing the take up spool engaging a series of slides;

FIG. 11 is a perspective view of part of a main panel of the cover assembly;

FIG. 12 is a perspective view of part of an anchor panel of the cover assembly;

FIG. 13 is a perspective view of part of a lead panel of the cover assembly;

FIG. 14 is a perspective view of a spring of the cover assembly;

FIG. 15 is a perspective view of a transmission housing including an air motor and gears;

FIG. 16 is a perspective view of a further embodiment of the drive and storage unit;

FIG. 17 is a perspective view of a railcar with a cover assembly, according to another embodiment of the present disclosure;

FIG. 18 is a cross-sectional view of the railcar shown in FIG. 17;

FIG. 19 is another cross-sectional view of the railcar shown in FIG. 17;

FIG. 20 is a perspective view of a further embodiment of the drive and storage unit with an empty spiral take up spool;

FIG. 21 is a cross-sectional view showing the empty spiral take up spool engaging a series of slides;

FIG. 22 is a perspective view of the drive and storage unit with the spiral take up spool partially full;

FIG. 23 is a perspective view of the drive and storage unit with the spiral take up spool full; and

FIG. 24 is a cross-sectional view showing the full spiral take up spool.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

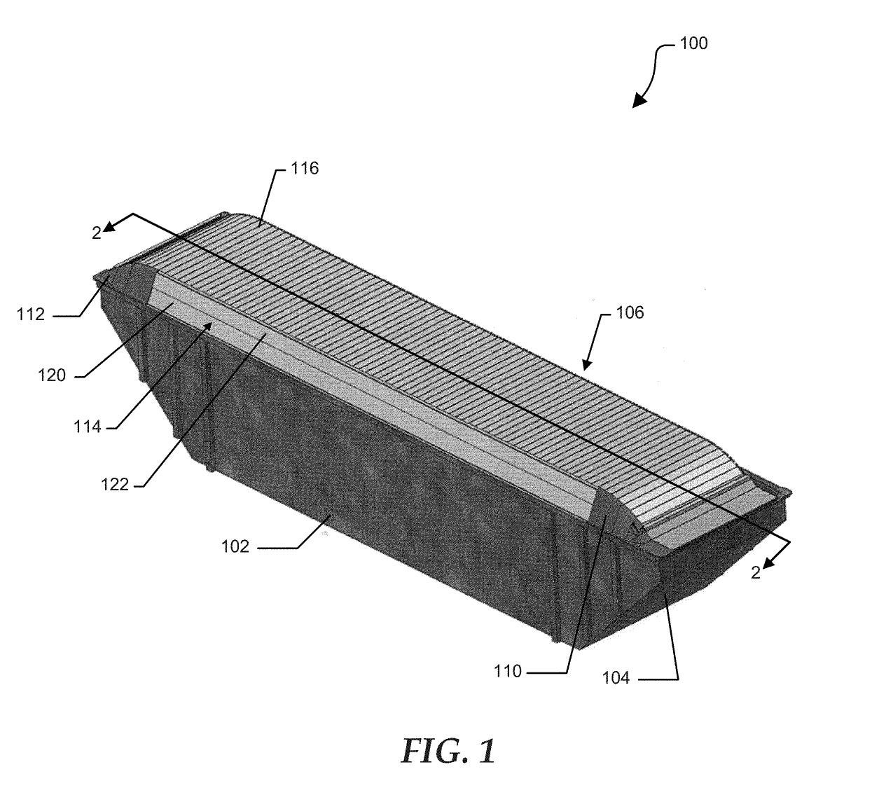

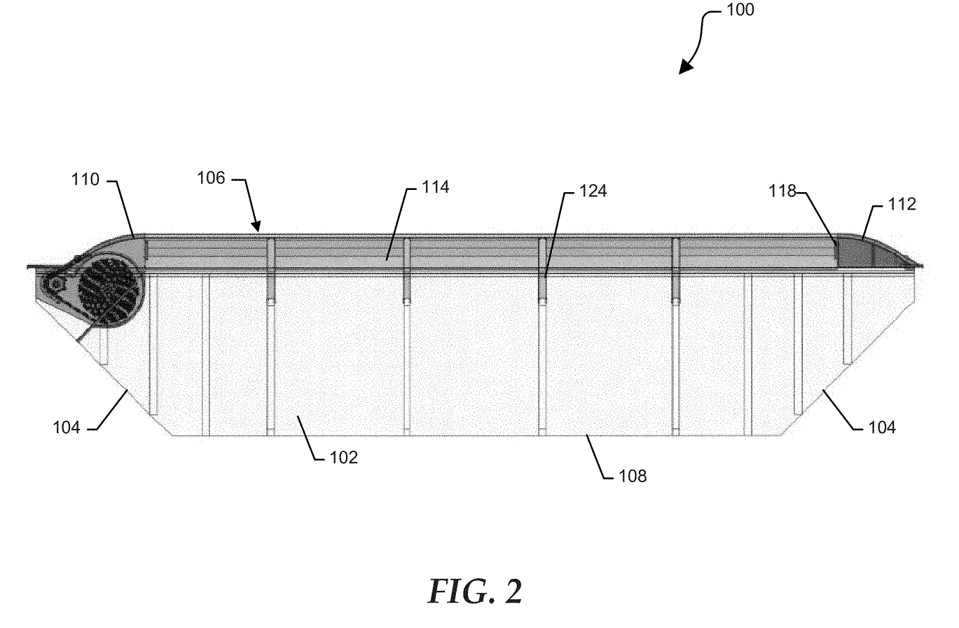

FIGS. 1 and 2 show a container 100 having side walls 102, end walls 104, and a cover assembly that includes retractable cover 106. The side walls 102 extend generally vertically, while the end walls 104 slope at about forty-five degree to the horizontal. In one particular embodiment, the container 100 may be outfitted as a railcar and adapted to transport coal. For this and similar applications, a bottom 108 of the railcar can include hopper doors that open outwardly to allow the contents of the railcar to dump out through the bottom.

The cover assembly 106 includes opposed end caps 110 and 112, side rails 114, and a series of panels 116. The end caps 110 and 112 are preferably aluminum castings that interlock with the side rails 114 in any suitable manner, such as by mounting extensions 118. The side rails are preferably formed by a lower extrusion 120 that is fixed, such as by rivets, to an upper extrusion 122. In one embodiment, the lower extrusions 120 may be fastened, such as by bolts or rivets, to both the top of the side walls 102 of the railcar and to braces or cross members in the interior of cars by a descending leg 124 that is best seen in FIG. 2. The upper extrusions 122 have an inwardly facing rectangular channel through which the ends of the panels 116 translate, as described more fully below.

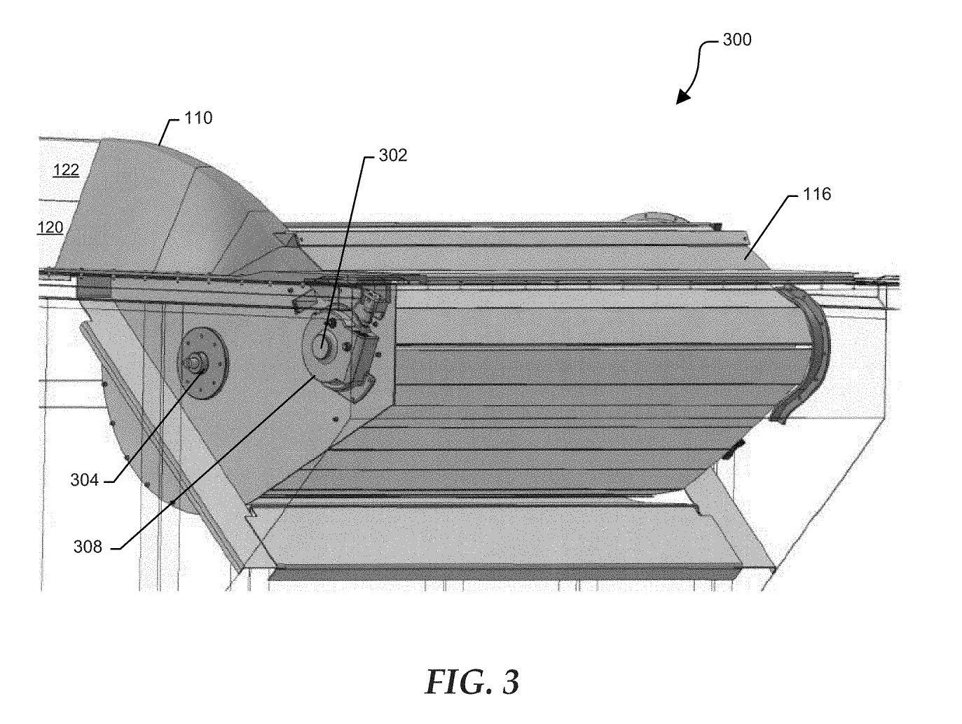

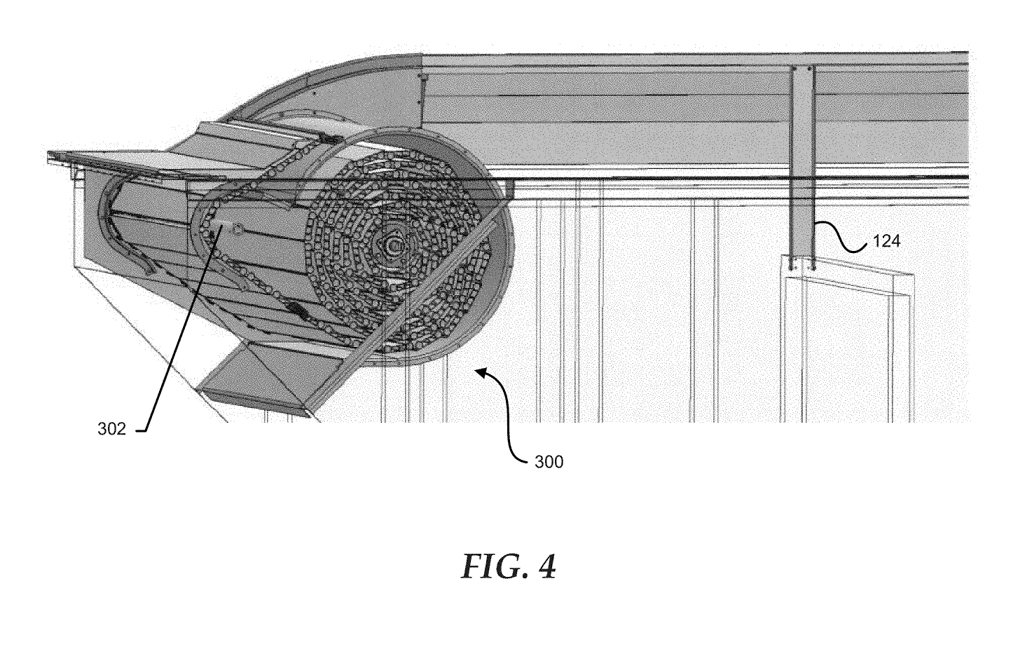

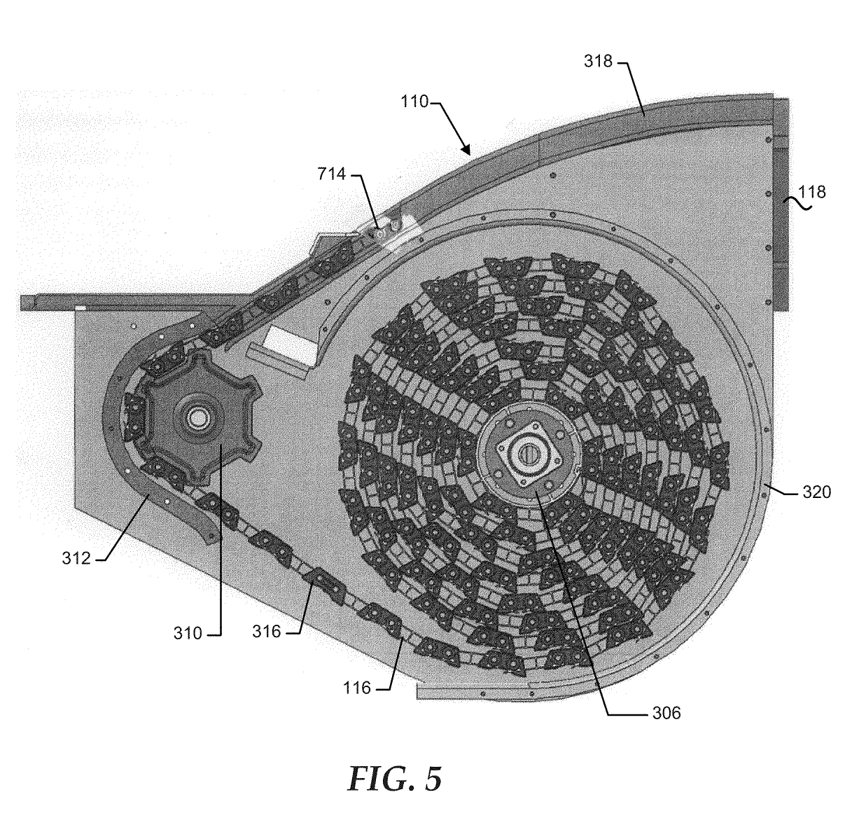

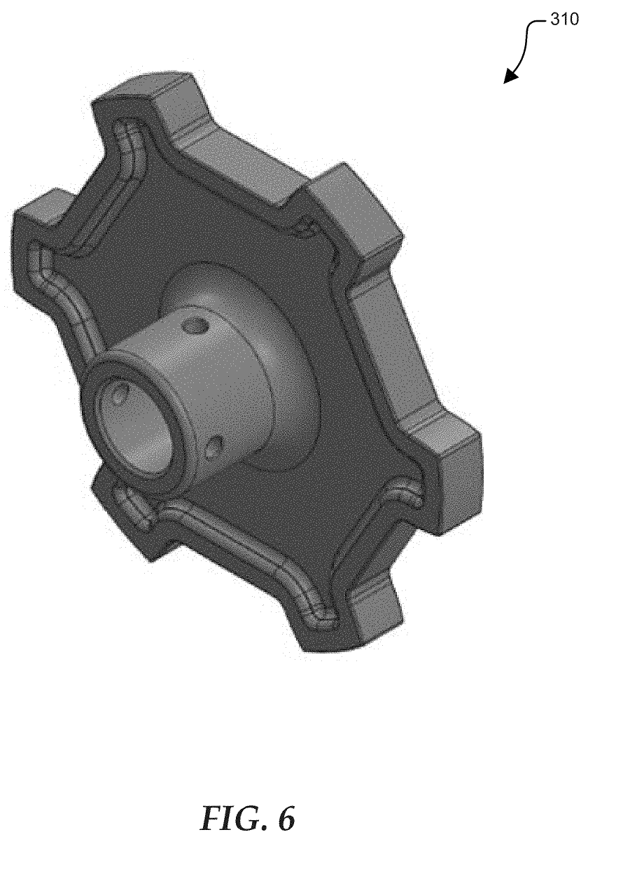

FIGS. 3-5 show a drive and storage unit 300 for powering the cover assembly 106 between extended and retracted positions. The drive and storage unit 300 includes a drive axle 302, a take up axle 304, and a take up spool 306. The drive axle 302 extends transversely across the railcar, and is supported at one end in a roller bearing assembly and is engaged at the other end with a gear motor 308. The drive axle 302 is rotationally fixed to a pair of sprockets 310, one of which is shown in isolation in FIG. 6. In one embodiment, the sprockets 310 are cast aluminum and each has six teeth, the faces of which are slightly convex and form an angle of about 71.8 degrees to one another.

The take up axle 304 is fixed with respect to the railcar, while the spool 306 is free to rotate about the take up axle on bearings. In one embodiment, the spool is an aluminum extrusion eleven inches in diameter. A cast aluminum guide 312 is riveted to the drive and storage unit 300. Slides 316 connect the panels 116 as described below. The guide 312 guides the slides 316 into engagement with the sprockets 310, and holds them in engagement until the slides enter into channels 318 formed in the end cap 110. A shield 320 is disposed mostly around the panels wound on the spool 306 and between the spool and the interior of the railcar.

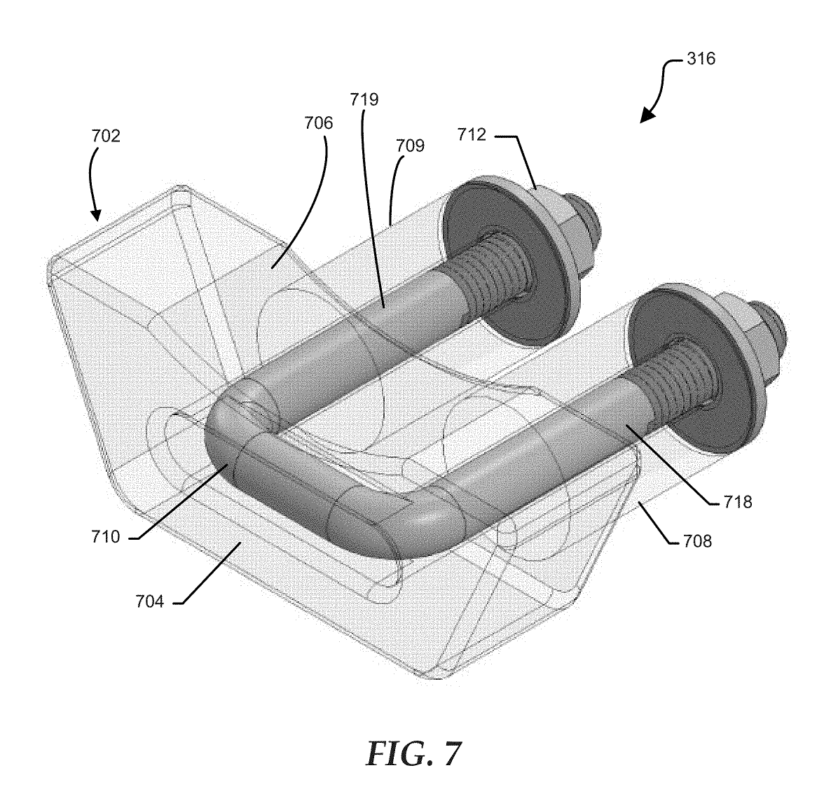

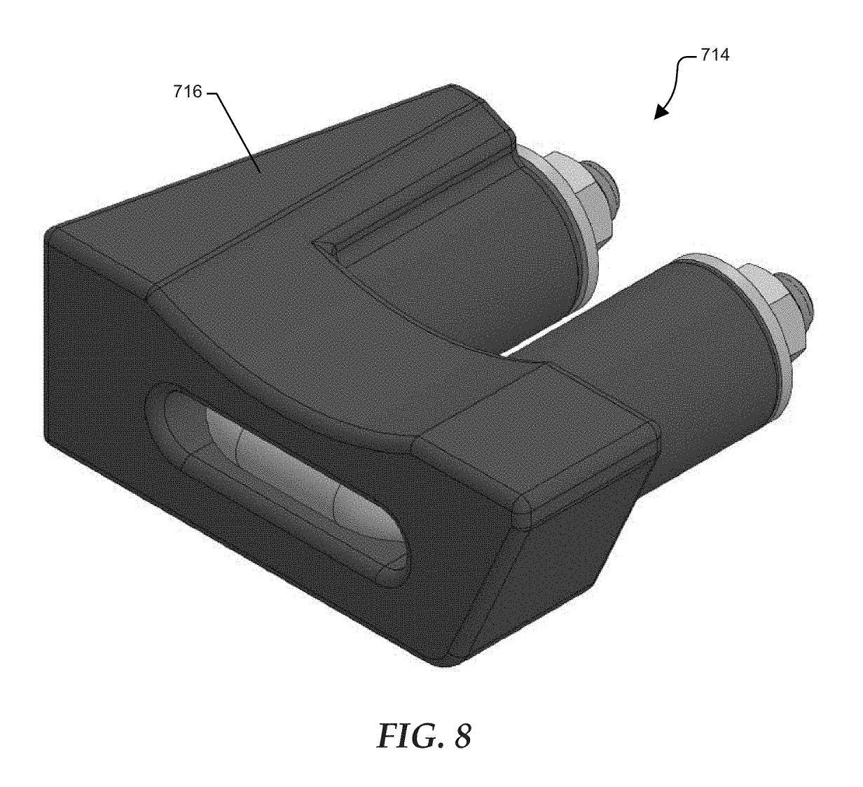

FIG. 7 shows one of the slides 316 in greater detail. Each slide has a body 702 that is preferably molded out of a polymer such as nylon. The body has a generally trapezoidal main section 704 with a concave portion 706, and a pair of legs 708 and 709 that extend from the main section. A U-bolt 710 is retained through the main section 704, and has legs 718 and 719 that extend through the corresponding legs 708 and 709 of the slide. Washers and nuts 712 retain the U-bolt 710 to the slide 316. In a preferred embodiment, the slides are slightly less that two inches tall and about five inches long, with a center distance between the legs 708 and 709 of about two inches. FIG. 8 shows a lead slide 714 having an edge 716 that acts as a track cleaner to clear light debris from the channel 318.

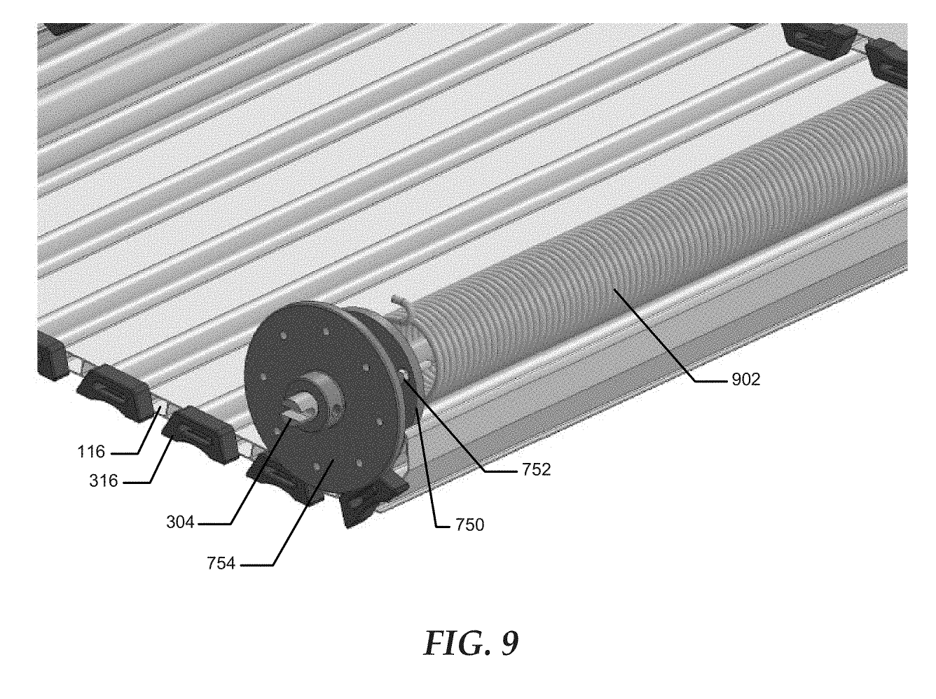

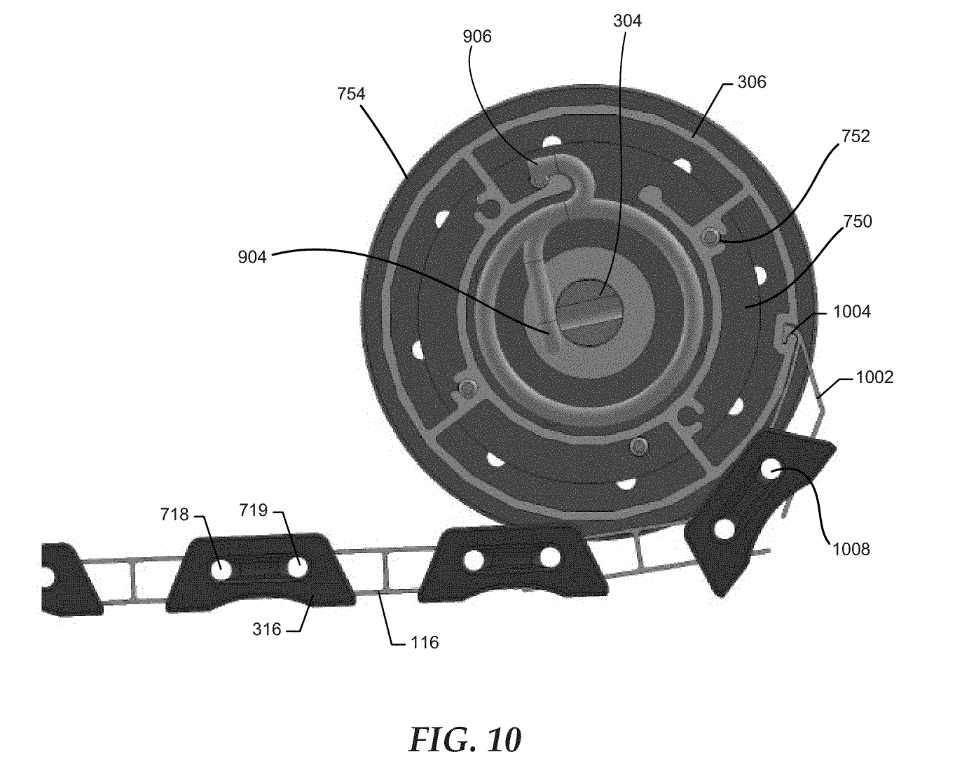

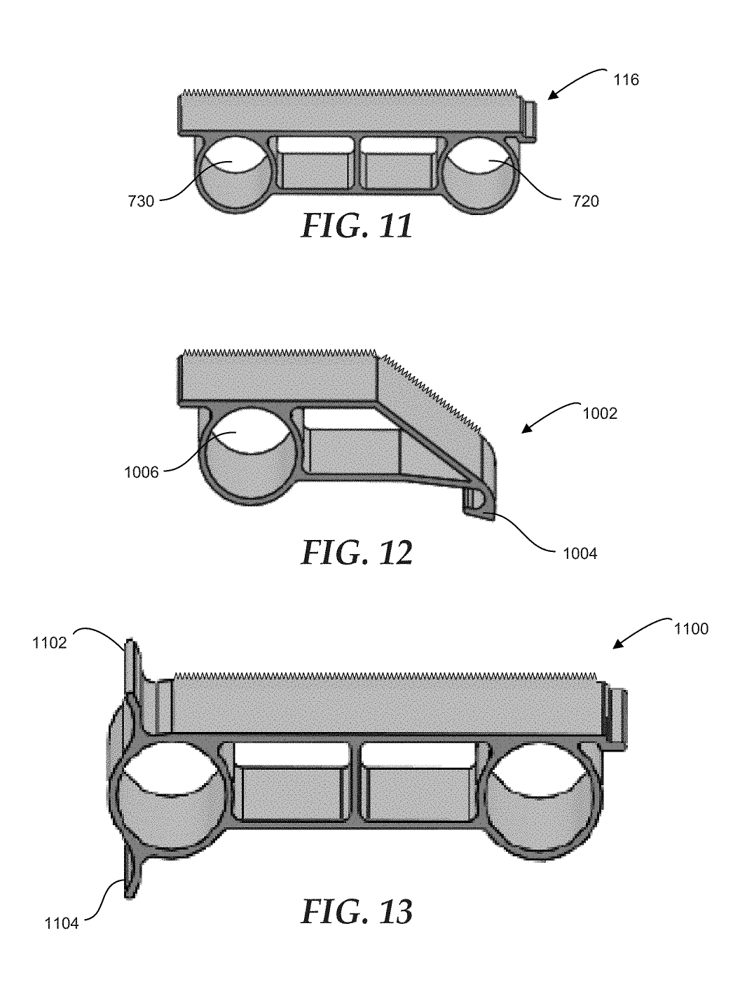

FIGS. 9 and 10 show a cover storage assembly with the cover in an almost fully extended position. Each slide 316 connects two adjacent panels 116. In particular, the leftmore (as shown) U-bolt leg 718 reinforces one leg of the slide that connects into a first hole 720 in one of the adjacent panels as shown in FIG. 11, and the rightmore U-bolt leg 719 supports the other leg of the slide that inserts into a similar hole 730 in the other adjacent panel. An anchor or terminal panel 1002, shown in isolation in FIG. 12, has a projection 1004 that is received in a mating groove in the take up spool 306. A single hole 1006 in the anchor panel accepts a U-bolt leg 1008 and its surrounding slide leg.

FIG. 13 shows a portion of a lead panel 1100. The lead panel 1100 is similar to the main panels 116, but is provided with flanges 1102 and 1104 to scrape off the top of any load in the railcar that might otherwise extend above the cover.

The take up spool 306 is fixed at each end to an adaptor casting 750, such as by bolts 752. In a preferred embodiment, only the panels make contact with the spool 306. The slides 316 ride in a lateral space between the adaptor 750 and a cast axle carrier 754, and around roller bearings disposed in that space and about the aluminum axle 304.

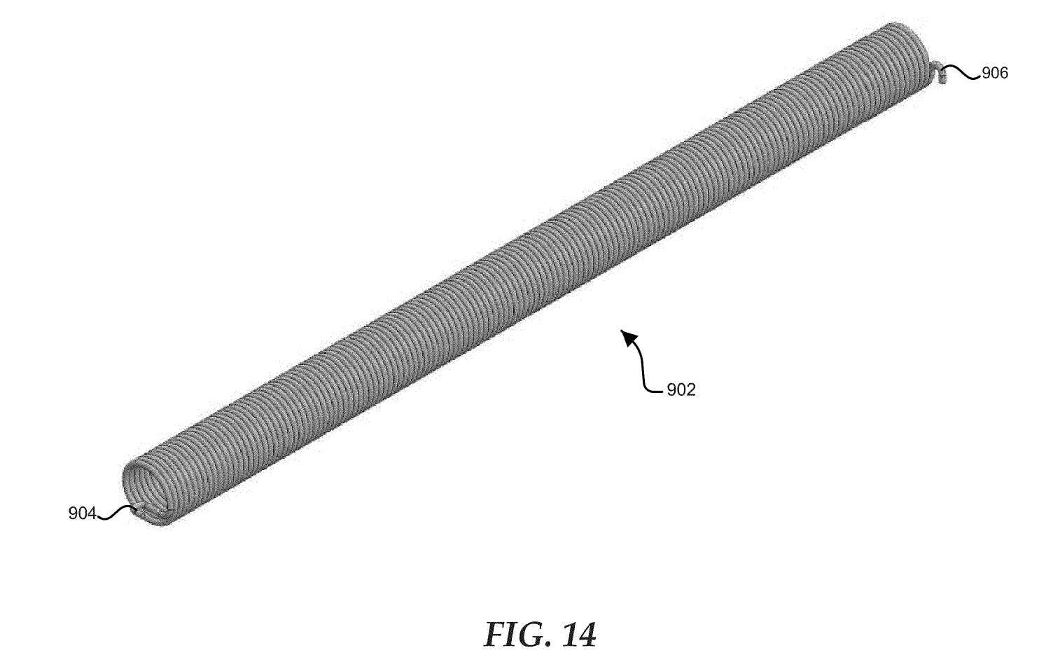

The take up spool 306 is normally biased in a counterclockwise direction as shown in FIG. 10 by a coil spring 902. The coil spring is disposed around the axle 304, which is preferably about one and three quarters inches in diameter. A polymer liner, such as one made of Teflon, may be disposed between the outside of the spring 902 and the inside of the spool 306 in order to minimize friction therebetween. One end 904 of the spring 902, best seen in FIG. 14, hooks into the stationary axle 304. An opposite end 906 of the spring hooks into the spool 306 so that the panels 116 are normally wound onto the spool to put the cover in a retracted position.

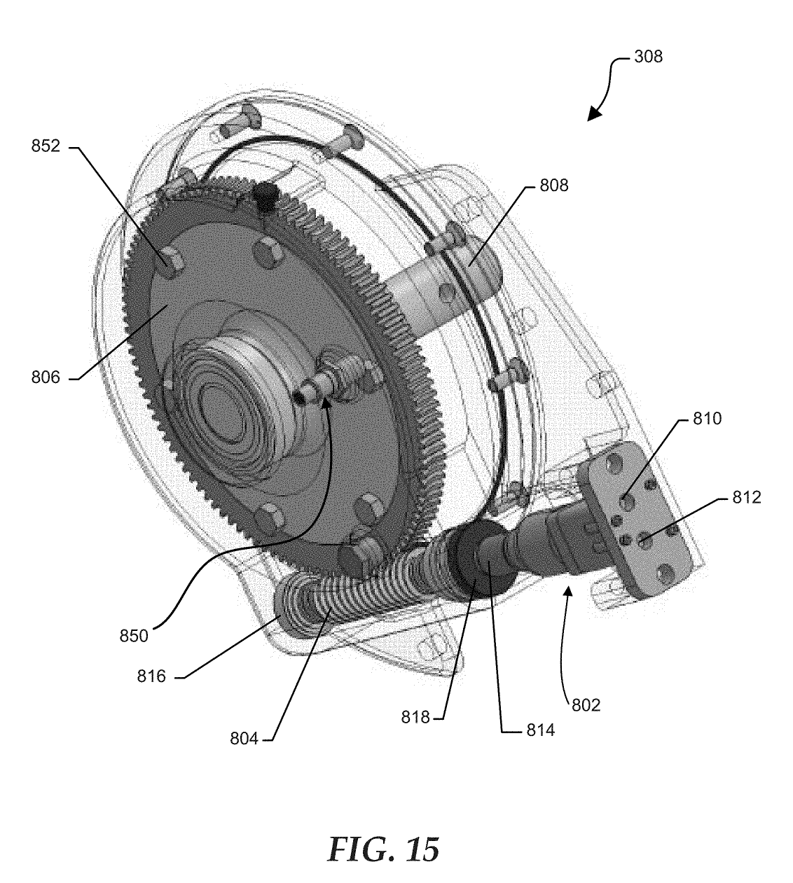

FIG. 15 shows the gear motor 308 including an air motor 802, a worm 804, an output gear 806 and an output shaft 808. The air motor 802 is preferably similar to those found in impact wrenches, and has an air inlet port 810 and an air outlet port 812. The ports 810 and 812 may be connected to a pneumatic system of the railcar (not shown) that normally includes storage tanks charged to about one hundred fifty pounds per square inch. While the air motor 802 can usually operate at a range of air pressures, a regulator may be added to regulate the pressure supplied to the air motor. The air motor drives a socket 814 with a torque in the range of about two hundred foot pounds. The socket 814 in turn drives the worm 804, which is mounted in roller bearings 816 and 818, at a ratio of about 120 to 1 so that about twenty-four thousand pounds of gross force is available to drive the output gear at the efficiency of the worm. An oil level preferably is maintained to cover the worm 804 in operation.

A proximity sensor 850 is provided through one wall of the gear motor 308. The proximity sensor 850 detects the position of the output gear 806, such as by incrementing or decrementing a counter according to the passage of bolt heads 852. In one embodiment the proximity sensor 850 operates magnetically, but it should be understood that the proximity sensor may operate in any other suitable manner such as optically.

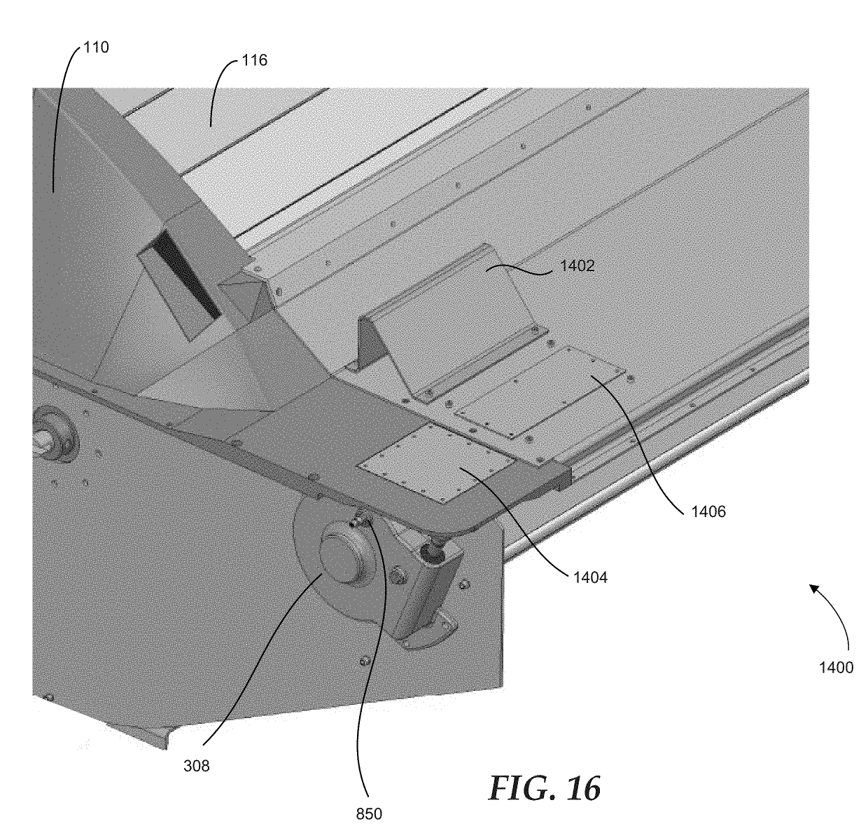

FIG. 16 shows an alternative embodiment 1400 of the drive and storage unit. The unit 1400 includes a mount 1402 for one or more solar panels, an access panel 1404, and an access panel 1406. The access panel 1404 is removable to allow access to components such as the gear motor 308 or the proximity sensor 850. The access panel 1406 is also removable to allow access to a tool box that may contain batteries rechargeable by the solar panels, a controller (not shown) powered primarily or secondarily by those batteries and connected to the proximity sensor 850 and to the motor 308, and air valves connected to the air motor.

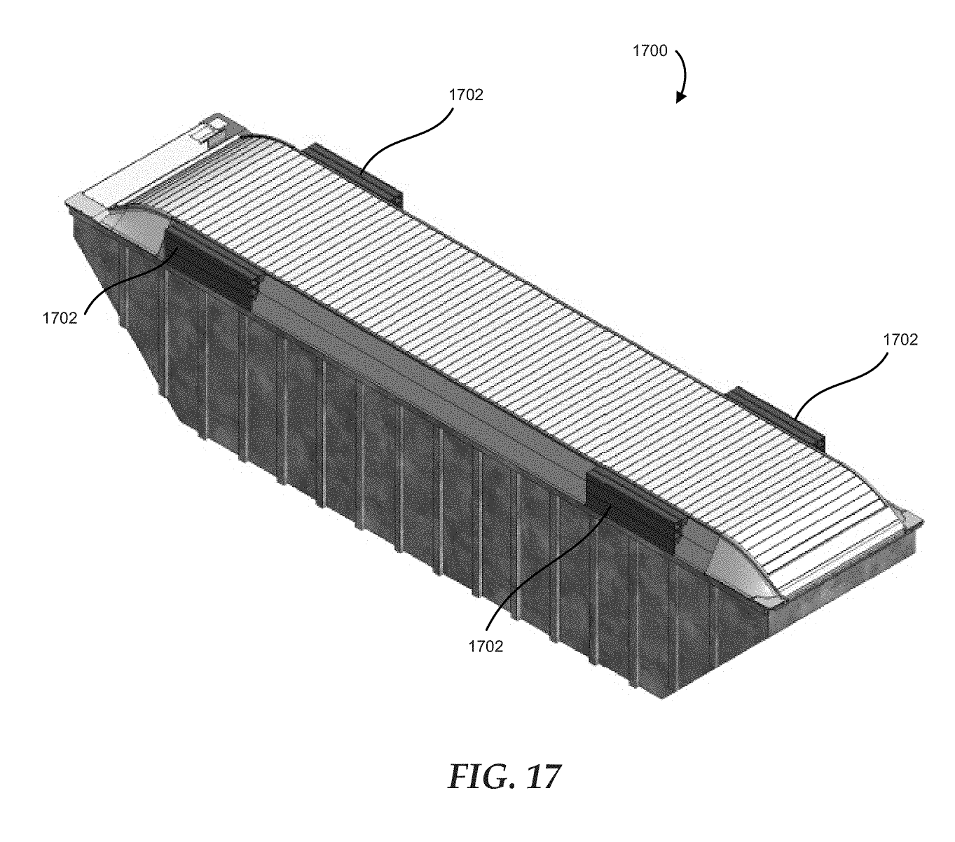

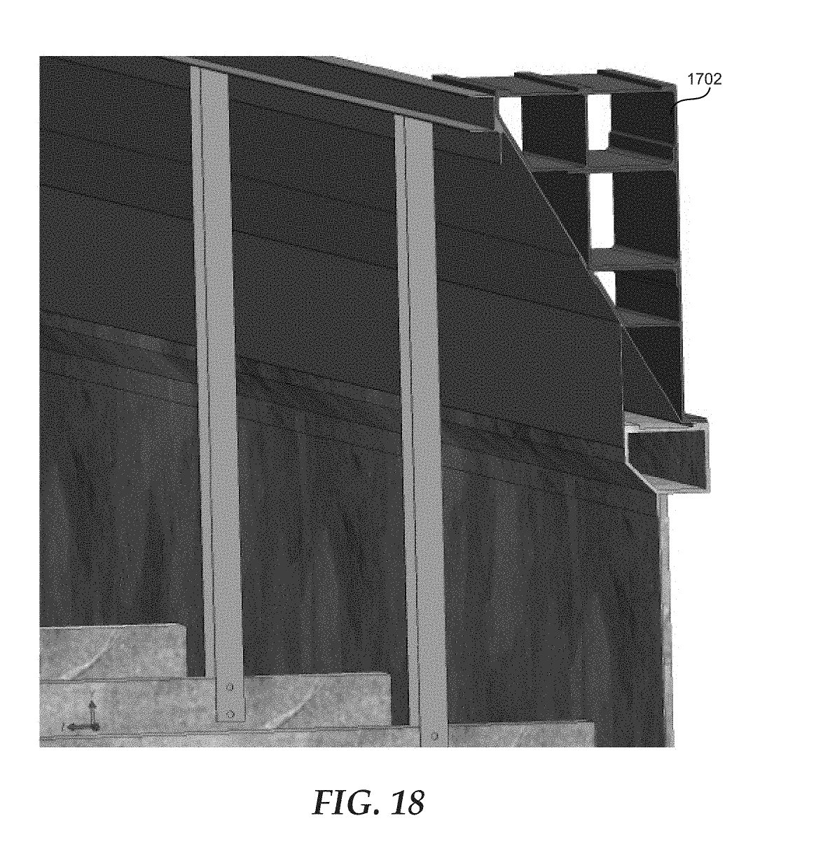

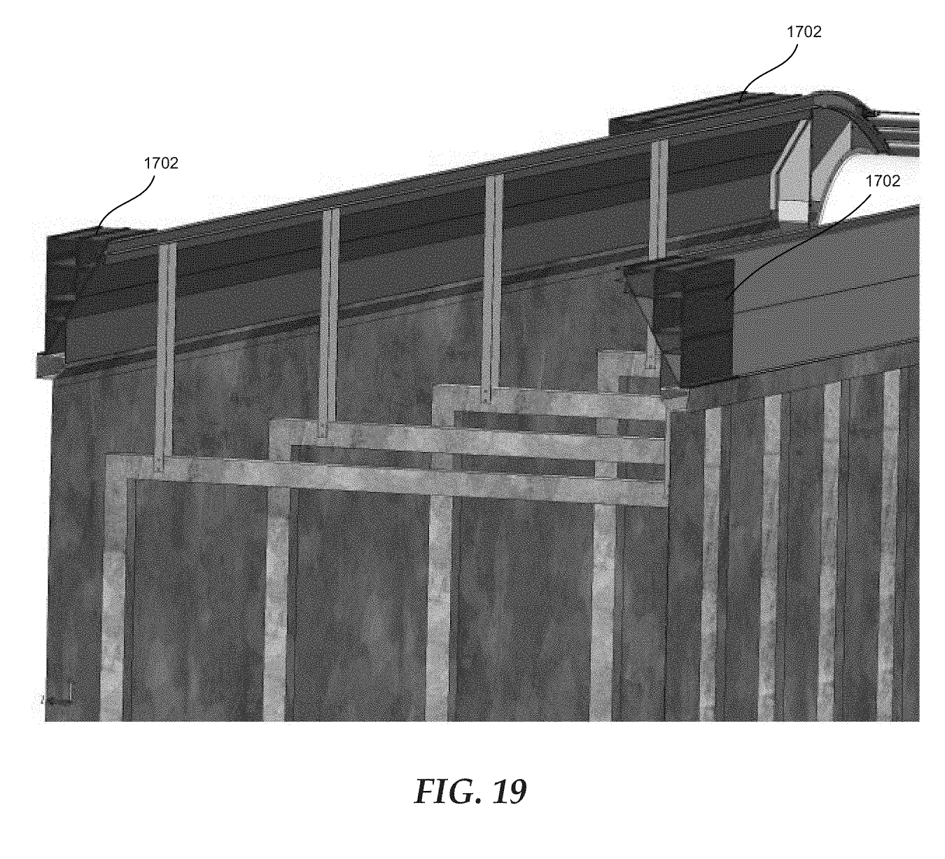

FIGS. 17 through 19 show another embodiment 1700 of a railcar with a cover assembly. The embodiment 1700 is particularly adapted for use with rotary dump railcars and includes four supports 1702. The supports 1702 preferably are made up from three aluminum extrusions that can be assembled without welds. In one embodiment, the components of the supports 1702 can be connected with pop rivets.

The supports 1702 include an upper surface situated to oppose and engage clamps (not shown) of a system designed to rotate the railcar one hundred and eighty degrees so as to release the contents of the railcar under the force of gravity. In particular, each support 1702 is pop riveted to the top of the corresponding side rail of the railcar in order to transmit forces between that point and the associated clamp.

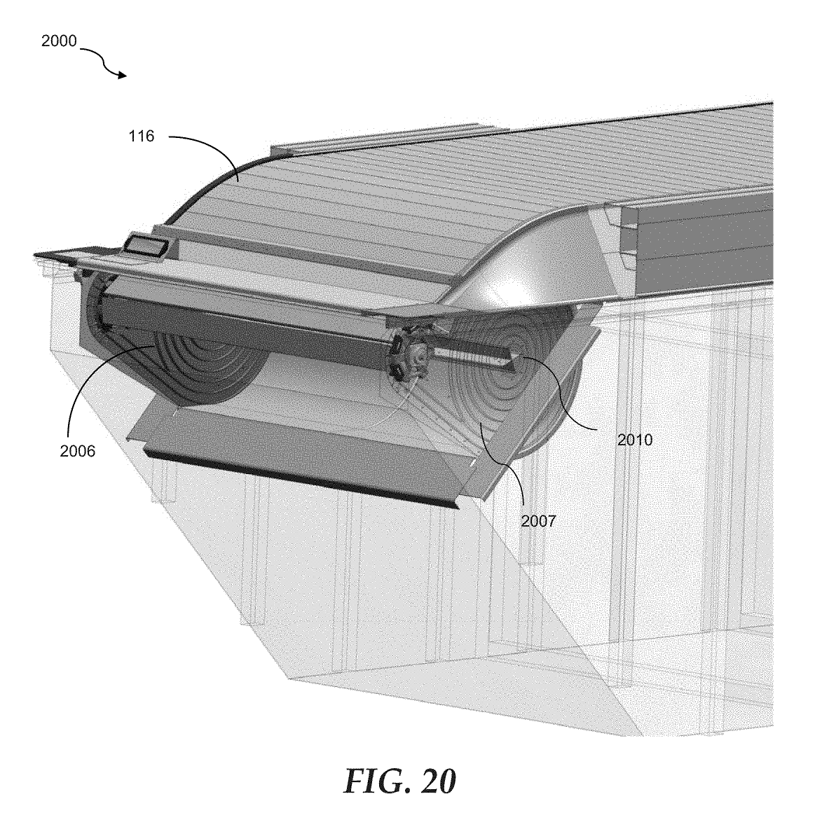

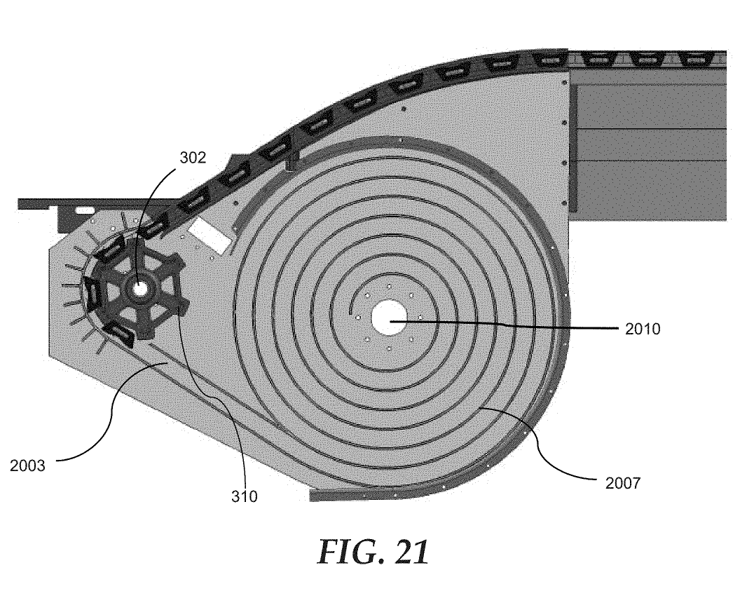

FIGS. 20-24 show a drive and storage unit 2000 for moving the panels 116 between extended and retracted positions. The drive and storage unit 2000 includes the drive axle 302 and a pair of opposed take up drums or spools 2006 and 2007. The drive axle 302 extends transversely across the railcar, and is supported at one end in a roller bearing assembly and is engaged at the other end with the bidirectional gear motor 308. The drive axle 302 is rotationally fixed to the sprockets 310, which drive the panels 116 into a polymer track 2003 that guides the opposed slides on to the respective lefthand spiral drum 2006 and righthand spiral drum 2007.

The spiral drums 2006 and 2007 may be made of or lined with the same polymer used for the track 2003, and may be glued and/or riveted to an aluminum end cap or plate (not shown). A cross bar 2010 may be screwed or otherwise attached to the end cap. In one embodiment, the polymer of the track 2003 and of the drums 2006 and 2007 is dissimilar to the polymer of the slides 316 in order to minimize the risk of galling that can be exacerbated by coal dust.

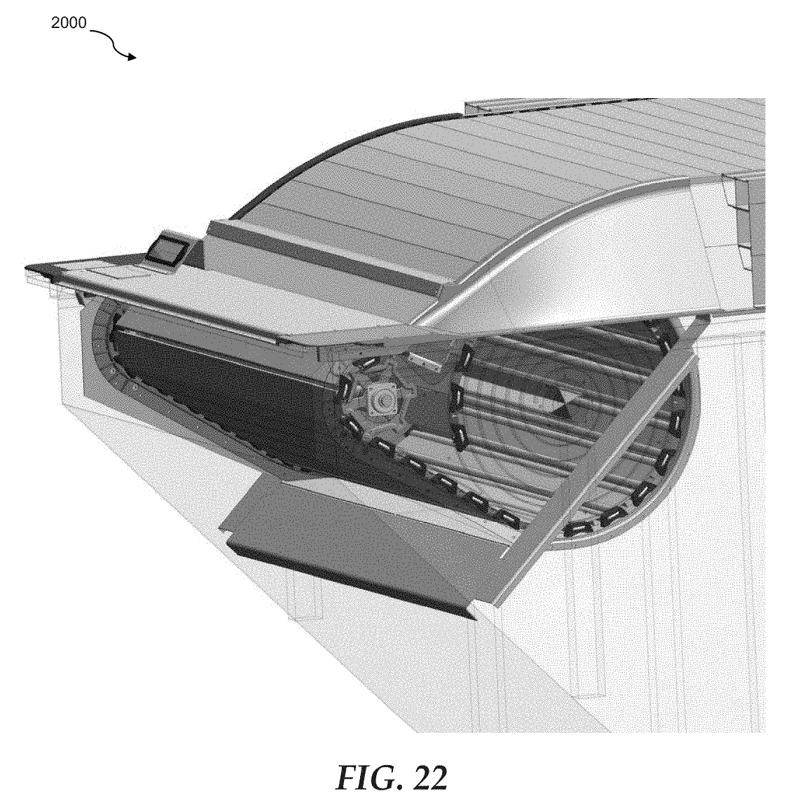

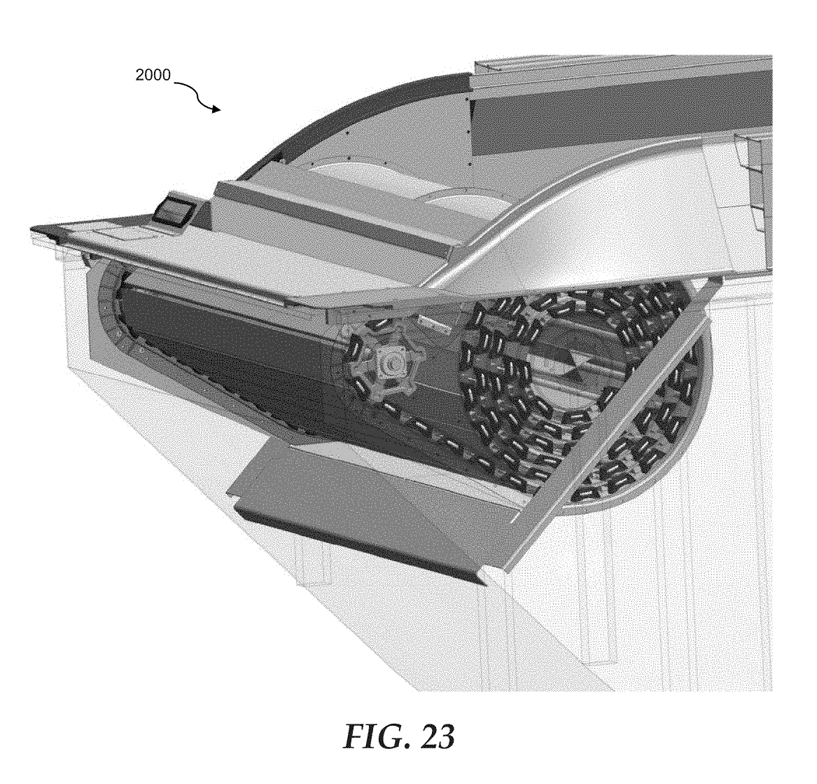

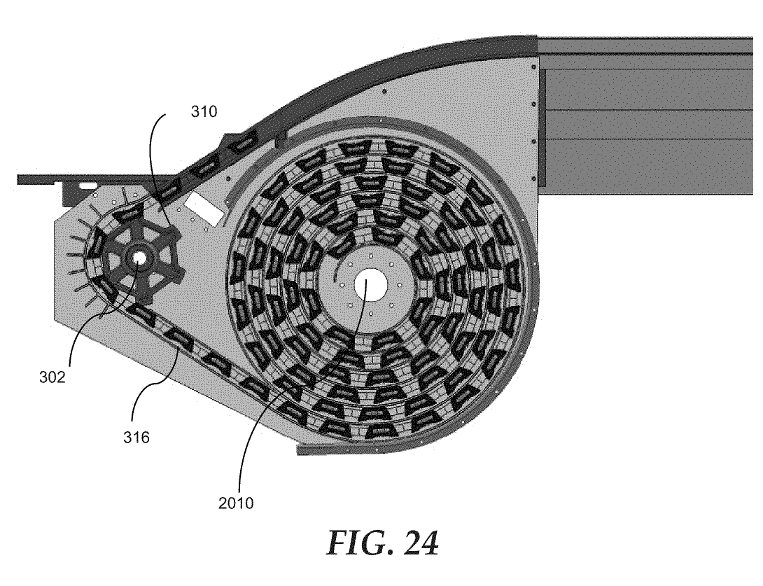

The sprockets 310 engage the slides 316 to drive the panels 116 through the position shown in FIG. 22 and to the fully retracted position shown in FIGS. 23 and 24. In all of these positions, the panels 116 never abrade against each other, further minimizing any galling. The unit 2000 thus presents a passive take up design rather than a spring loaded take up design such as shown and described above.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims.

What is claimed is:

1. A rotary railcar comprising:
a pair of opposed sidewalls, each sidewall having a top;
a first support disposed on the top of one of the sidewalls; and
a second support disposed on the top of the other of the sidewalls;
wherein the first support and the second support are configured to engage clamps to facilitate rotation of the railcar.

2. The railcar of claim 1 further comprising a cover including a plurality of panels extending between the sidewalls, and a take up spool where the panels may be stored.

3. The railcar of claim 2 further comprising a motor drivingly engaged with the panels to move the cover between a retracted position and an extended position, and a side rail mounted to each sidewall, each side rail accepting an end of the panels.

4. The railcar of claim 3 further comprising a plurality of slides interconnecting the panels, wherein each slide is disposed in one of the side rails.

5. The railcar of claim 1 wherein the first support and the second support each include a plurality of extrusions.

6. The railcar of claim 5 wherein the extrusions are aluminum.

7. The railcar of claim 5 wherein the extrusions are connected with pop rivets.

8. A rotary railcar comprising:
a pair of opposed sidewalls, each sidewall having a top;
a first support riveted to the top of one of the sidewalls; and
a second support riveted to the top of the other of the sidewalls;
wherein the first support and the second support are configured to engage clamps to facilitate rotation of the railcar.

9. The railcar of claim 8 further comprising a cover including a plurality of panels extending between the sidewalls, and a take up spool where the panels may be stored.

10. The railcar of claim 9 further comprising a motor drivingly engaged with the panels to move the cover between a retracted position and an extended position, and a side rail mounted to each sidewall, each side rail accepting an end of the panels.

11. The railcar of claim 10 further comprising a plurality of slides interconnecting the panels, wherein each slide is disposed in one of the side rails.

12. The railcar of claim 8 wherein the first support and the second support each include a plurality of extrusions.

13. The railcar of claim 12 wherein the extrusions are aluminum.

14. The railcar of claim 12 wherein the extrusions are connected with pop rivets.

15. A railcar rotatable through one hundred and eighty degrees, the railcar comprising:
a pair of opposed sidewalls, each sidewall having a top;
a plurality of first supports disposed on the top of one of the sidewalls; and
a plurality of second supports disposed on the top of the other of the sidewalls;
wherein the first supports and the second supports are configured to engage clamps to facilitate rotation of the railcar to release contents of the railcar under the force of gravity.

16. The railcar of claim 15 further comprising a cover including a plurality of panels extending between the sidewalls, and a take up spool where the panels may be stored.

17. The railcar of claim 16 wherein the first supports and the second supports each include a plurality of extrusions.

18. The railcar of claim 17 wherein the extrusions are aluminum.

19. The railcar of claim 17 wherein the extrusions are connected with pop rivets.
